(19) United States
(12) Patent Application Publication
(10) Pub. No.: US 2019/0113072 A1
(43) Pub. Date: Apr. 18, 2019

(54) Multi-Directional Mounting Bracket

(71) Applicant: QUEST ENGINEERING PTY LTD, Tullamarine, Victoria (AU)

(72) Inventors: Michael CHIJOFF, Tullamarine (AU); Mark LADEWIG, Plenty (AU)

(73) Assignee: QUEST ENGINEERING PTY LTD, Tullamarine, Victoria (AU)

(21) Appl. No.: 16/089,723

(22) PCT Filed: Mar. 30, 2017
(86) PCT No.: PCT/AU2017/050274

§ 371 Date: Sep. 28, 2018

(30) Foreign Application Priority Data
Mar. 31, 2016 (AU) 2016901190

(51) Int. Cl. F16C 11/10; F16C 11/06; F16M 13/02

(52) U.S. Cl. CPC F16C 11/10; F16C 11/0609; F16C 11/0623; F21V 21/28; F16M 13/02; F16M 2200/024; F16C 11/0642

(57) ABSTRACT

A multi-directional mounting bracket for adjustably mounting an object to a structure, such as a loudspeaker is disclosed. The mounting bracket incorporates a ball and socket mounting arrangement. Locking means including an array of indentations is provided, wherein the indentations define a plurality of predetermined positions.

### FIELD OF THE INVENTION

The present invention relates to a multi-directional mounting bracket for adjustably mounting an object to a structure. It finds particular, though not exclusive, application in the mounting of loudspeakers.

### BACKGROUND OF THE INVENTION

Wall brackets for mounting loudspeakers are well known. They are often used in commercial buildings, such as bars, hotels, casinos, office buildings, and other commercial establishments. Swivel mountings have been utilised to allow speakers to be orientated and reorientated to change the direction they project the sound. Known swivel mountings generally have a number of undesirable drawbacks.

Current solutions that allow multi-directional positioning are typically complex, cumbersome and it is difficult to enable replication of positions when arranging multiple speakers. Typically tools are required in the installation of speakers to brackets to fix them in position. They also require the user to exert an excessive amount of force to ensure the bracket is locked in position and to stop potential sag. Visually, many mounting systems are a cumbersome imposition on a speaker cabinet design and are added as a functional afterthought.

Often it is difficult and dangerous for an individual to install a speaker alone. This requires the installer to hold a speaker in position whilst using a tool often at the back of the speaker to secure it in position. This is carried out without the installer seeing what they are doing. As a result it is often required for two installers to be present and carry out the installation. This adds to the cost of installation.

In a number of known systems a friction grip to a static ball is used. The ball is clamped in a jaw type arrangement. The ball can be deformed by the jaw. This can result in a permanent deformation on the ball and any slight adjustment results in the jaw/ball combination being encouraged to go back into their original position. It has also been observed that these ball type mounts allow the speaker to sag over time. This appears to be due to a combination of the ball material, the leverage and weight of the speaker, as well as the effects of cyclic temperature change in a venue.

It is therefore desired to provide an alternative multi-directional mounting bracket that overcomes at least some of the above identified problems, or provides an alternative option.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

According to a first aspect, the present invention provides a multi-directional mounting bracket for adjustably mounting an object to a structure, including:
a first attachment means for attachment to the structure;
a second attachment means for attachment to an object to be supported;
a ball mount;
a socket for receiving the ball mount;
the ball mount and the socket connected to a respective first or second attachment means;
fastening means for securing the ball mount into the socket; and
locking means including an array of indentations on at least a portion of the surface of the ball mount or the socket, and a locking pin projecting from the other of the socket or the ball mount;
wherein the indentations define a plurality of predetermined positions whereby the locking pin can engage in an indentation and the fastening means locks that orientation, and wherein the fastening device can be loosened to disengage the locking pin from the indentation to allow reorientation of the object.

According to a preferred embodiment, the array of indentations are located on the ball mount and the locking pin projects partially into the socket.

Preferably the first attachment means is an attachment plate for attachment to the structure. The second attachment means is preferably a second attachment plate having a first face for attachment to an object to be supported.

There may be provided a boss, projecting from a second face of the second attachment plate, the boss having an external thread, the inside of the boss forming the socket for receiving the ball mount. The fastening means may be a locking nut having an internal thread for engagement with the external thread of the boss.

The ball mount may be connected to the first attachment plate by an arm.

The socket and the fastening device preferably form a spherical housing when connected together for locking the ball mount in a predetermined position.

The object to be supported may be a loudspeaker or the like, or a lighting fixture such as directional lighting. The second attachment plate preferably attaches to the rear wall of object.

The ball mount may have a number of indentations positioned on the exterior of the ball, preferably in a radial arrangement originating from the centre of the ball. The indentations may cover a small segment of the ball, or may cover half of the spherical ball surface.

The array of indentations may be provided as an insert into the ball body. Alternatively the indentations are provided directly into the ball body. The indentations may either be domed or cone shaped, allowing rotation around the locking pin to reorientate the object about a pivot point.

In an alternative embodiment, the indentations may be provided in the socket. The indentations may cover a small segment of the socket, or may cover the entire socket.

The indentations are spaced to allow enough material between the indentations to stop the weight of the object from deforming and causing failure between the indentations.

A preferred embodiment has a radial array running along the x-axis with a conical type indentation of approximately 1.5 mm in depth and 2.8 mm in diameter. This allows a 10 degree pattern spread across the x-axis with approximately 0.3 mm between each indentation. Each offset radial pattern is then nestled into the next creating a similar 10 degree radial array in the y-axis.

The angular spacing between the indentations and size of indentations can be increased or decreased as required but are limited to the strength of the material being used and the ability of the material to hold the required weight of the object without causing the indentation to fail.

It is advantageous that the fastening device allows the ball mount to be secured in the socket and hold the weight of the object without the indentation being engaged by the locking pin. Once the object has been positioned in the desired orientation, the fastening device clamps the ball into the socket pushing an indentation over the locking pin.

It is preferable that the fastening device is able to be hand operated without the need for additional tools.

The locking pin is preferably made from a hardened type of metal, for example hardened alloy steel, stainless steel, tool steel.

In one embodiment the mounting bracket may provide multiple ball mounts, whereby multiple objects may be suspended from a single mounting assembly.

### BRIEF DESCRIPTION OF THE DRAWINGS

Further aspects of the present invention and further embodiments of the aspects described in the preceding paragraphs will become apparent from the following description, given by way of example and with reference to the accompanying drawings, in which:

FIG. 1 is a side view of a speaker mounted to a wall by a multidirectional mounting bracket according to the present invention;

FIG. 2 is a perspective view of the mounting bracket;

FIG. 3 is a perspective exploded view of the mounting bracket from a first direction according to a first embodiment;

FIG. 4 is a perspective view of the wall side components of the mounting bracket according to the first embodiment;

FIG. 5 is a perspective exploded view of the mounting bracket from a second direction according to a second embodiment;

FIG. 6a is an end view of the ball mount according to the second embodiment;

FIG. 6b is an end view of the ball mount according to the first embodiment;

FIG. 7 is a cross-sectional side view of the mounting bracket according the first embodiment;

FIG. 8 is a cross-sectional side view of the mounting bracket of FIG. 7 attached to the wall and speaker with a locking nut in a release position; and

FIG. 9 is a cross-sectional side view of the mounting bracket of FIG. 7 in a fully supported position.

### DETAILED DESCRIPTION OF THE EMBODIMENTS

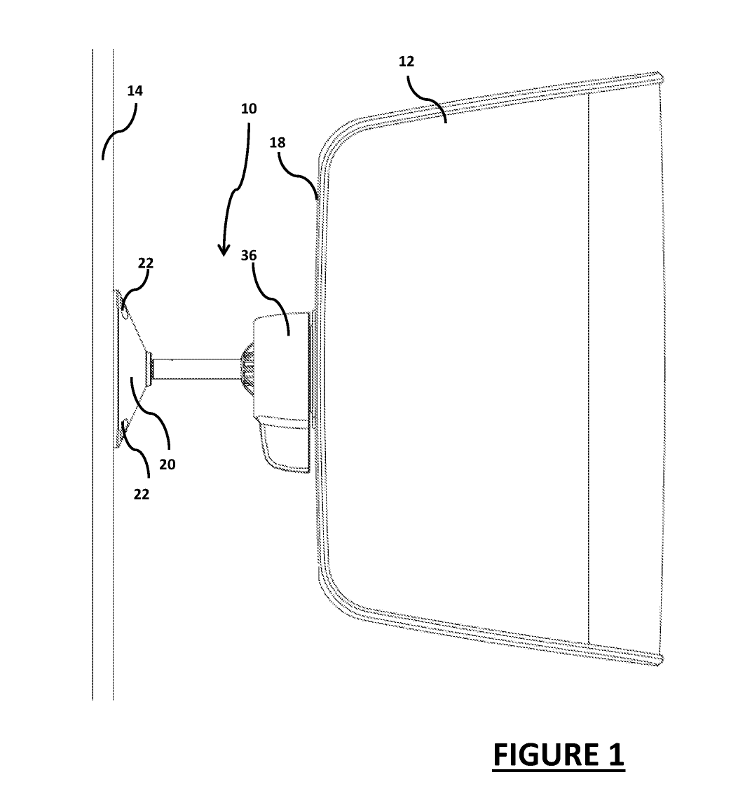

FIG. 1 shows a multi-directional mounting bracket 10 for mounting an object in the form of the loudspeaker 12 to a wall surface 14. The mounting bracket 10 allows for multi-directional reorientation of the speaker 12 relative to the wall surface 14. The mounting bracket 10 may be used to attach a loudspeaker or any other suitable object, to any suitable structure, such as a wall, ceiling, floor or freestanding panel.

The mounting bracket 10 is constructed as two separate modules. The first module is attachable to the wall surface and the second module is attachable to the rear wall 18 of the object to be suspended, such as loudspeaker 12.

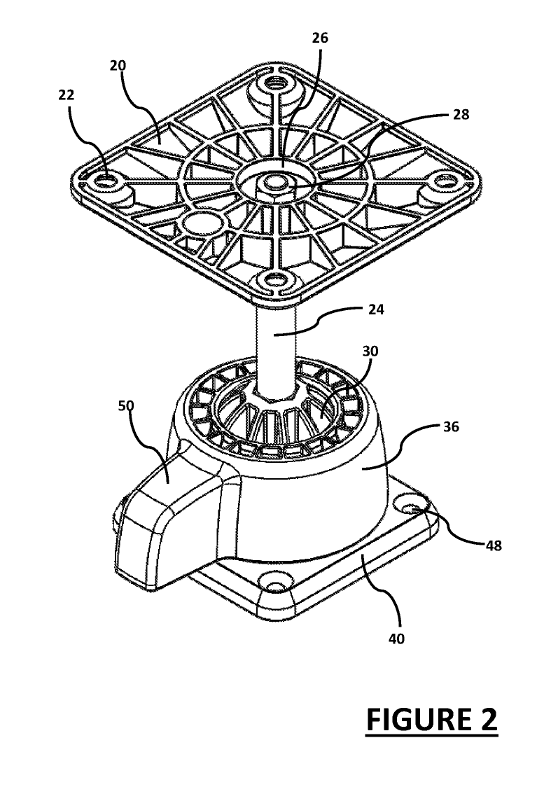

In the embodiment illustrated, the first module is comprised of a first attachment means, in the form of a wall plate 20. The wall plate 20 attaches to the wall 14 via a series of screws (not shown) projecting through a series of apertures 22. Extending from the wall plate 20 is a rod or arm 24. The arm 24 attaches to the wall plate 20 by projecting through a central aperture 26 in the wall plate 20 and being secured in place by nut 28 fastening to the threaded end of arm 24. This can be seen in FIG. 2.

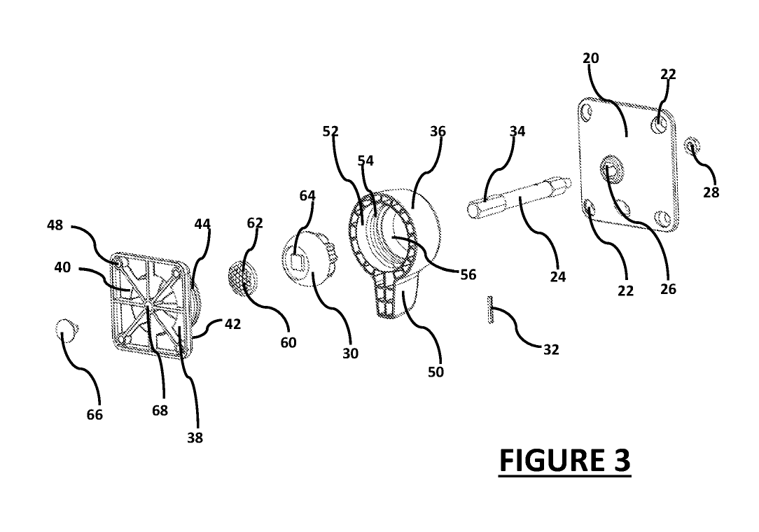

Attached to the end of the arm 24 is a ball mount 30, which is generally spherical. As shown in FIG. 3, the ball mount 30 is attached to the distal end of arm 24 by a locking pin 32 that projects through the ball mount 30 and through an aperture 34 in the distal end of arm 24.

Also located around the arm 24 is a locking nut 36, to be described further below.

The second module is comprised of a second attachment means, in the form of a second attachment plate 38 having a first face 40 for attachment to the loudspeaker 12. The second attachment plate 38 attaches to the rear wall 18 of the loudspeaker 12 via a series of screws (not shown) through apertures 48.

Projecting from a second face 42 is a boss 44. Boss 44 has an external thread. The inside of the boss 44 is formed as a socket 46 and is a hemispherical bowl. The socket 46 is generally sized and shaped to receive a portion of the ball mount 30.

The locking nut 36 mentioned above is generally cylindrical, with a lever 50 projecting from one side. Inside the locking nut is a channel having a first portion and a second portion. The first portion 52 is sized and shaped to sit externally around the boss 44 and includes a threaded portion 54. The second portion 56 includes a truncated hemispherical bowl portion, such as to receive a portion of the ball mount 30. As can be seen from the drawings the locking nut 36 sits about the ball mount and boss when in an engaged position. The hemispherical socket 46 and hemispherical portion of the locking nut 36 form a spherical housing when connected together for clamping about the ball mount 30 and locking the first module to the second module in the desired orientation.

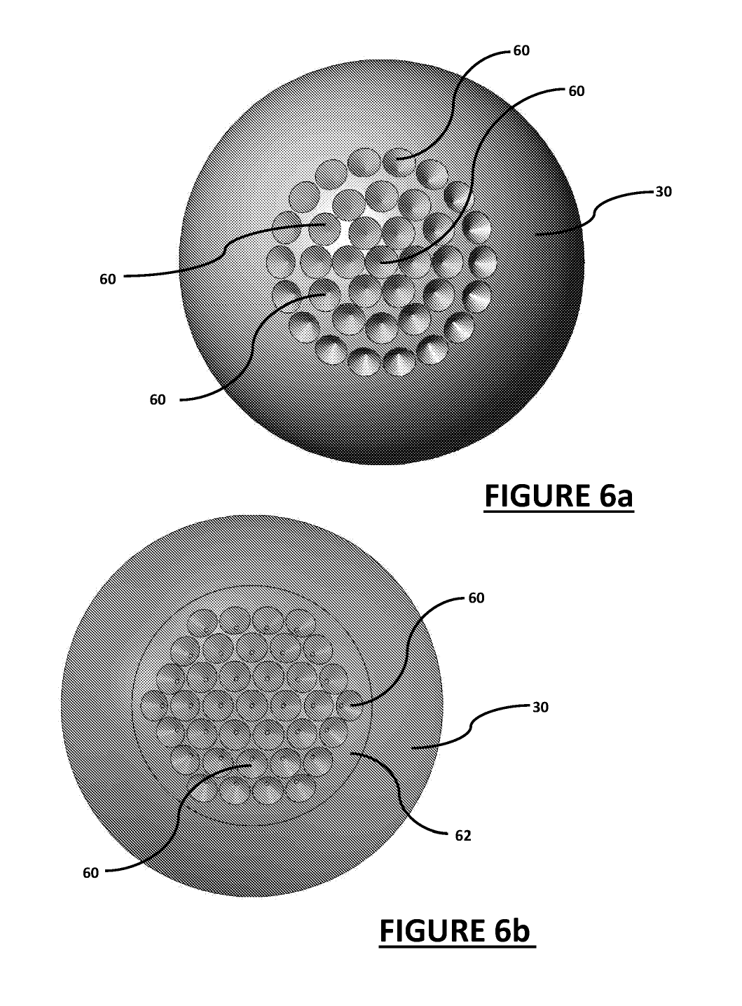

The ball mount 30 has an array of indentations 60. The indentations 60 may be a radial type array arranged in a circular pattern radiating from the centre of the ball, as shown in FIG. 6a. The embodiment illustrated has a radial array running along the x-axis with a conical type indentation of approximately 1.5 mm in depth and 2.8 mm in diameter. This allows a 10 degree pattern spread across the x-axis with approximately 0.3 mm between each indentation. Each offset radial pattern is then nestled into the next creating a similar 10 degree radial array in the y-axis. Additional offset radial patterns may be added to provide a greater degree of rotation to the speaker.

The angular spacing between the indentations and size of indentations can be increased or decreased as required but are limited to the strength of the material being used and the ability of the material to hold the required weight of the object without causing the indentation to fail.

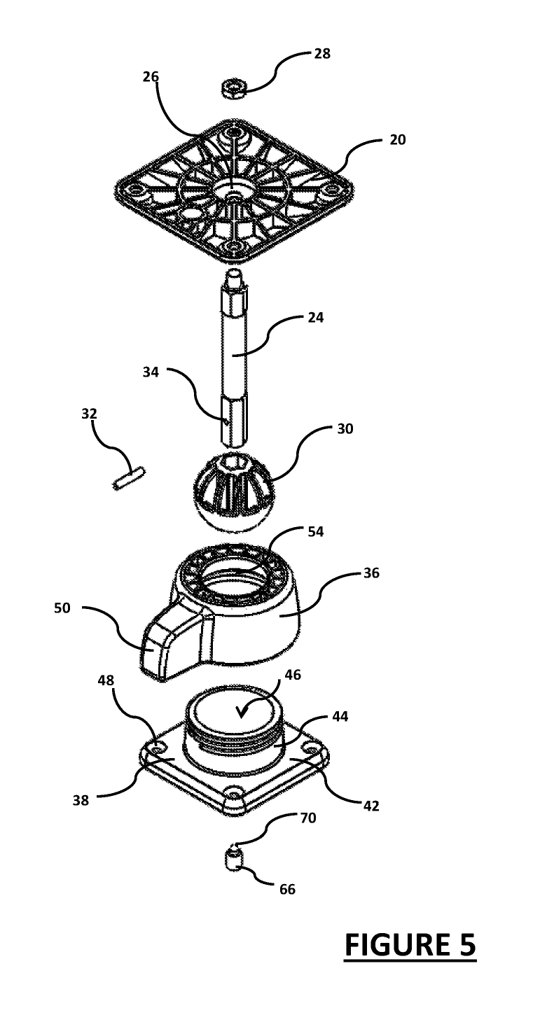

The indentations may be provided as an integral moulding within the ball mount 30 as shown in FIGS. 5 and 6a. One method to produce this could be to use injection moulding to create the ball. If using a two-part mould, the size, spacing and pattern of the indentations are crucial.

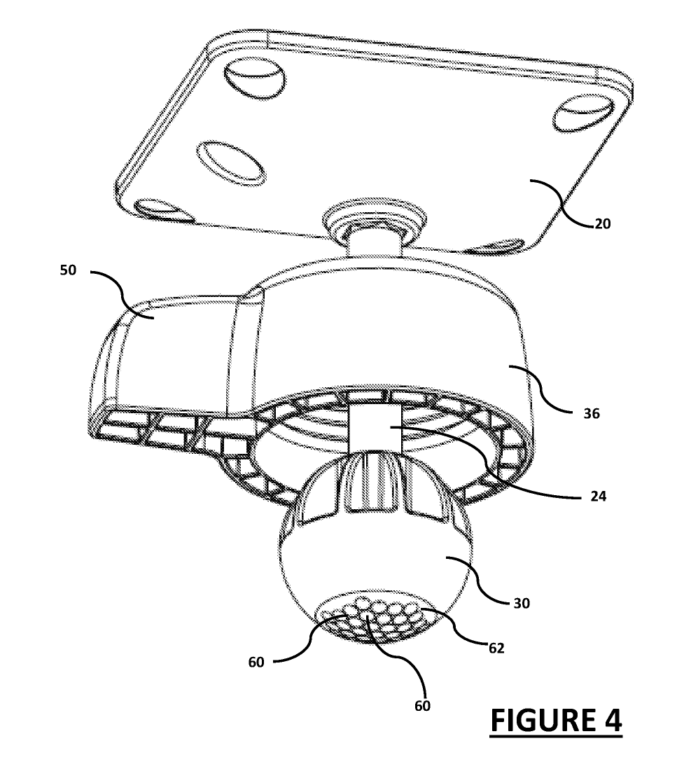

An alternative radial type array is shown in FIG. 6b, whereby the radial type array is arranged in a hexagonal pattern. Each of the indentations is conical, ending in a point. The indentations may be provided as an insert 62 as shown in FIGS. 3, 4 and 6b through 9. The insert 62 may be made from hardened material such as forged steel. The insert 62 is press fit into a depression 64 in the end of the ball mount 30. Depending on the type of pattern array used the insert can be then pulled out and turned 90 degrees to enable a new positioning in the perpendicular axis. The spacing between each indentation needs to provide enough material between the indentations to stop the weight of the speaker from deforming the material and causing failure between the indentations.

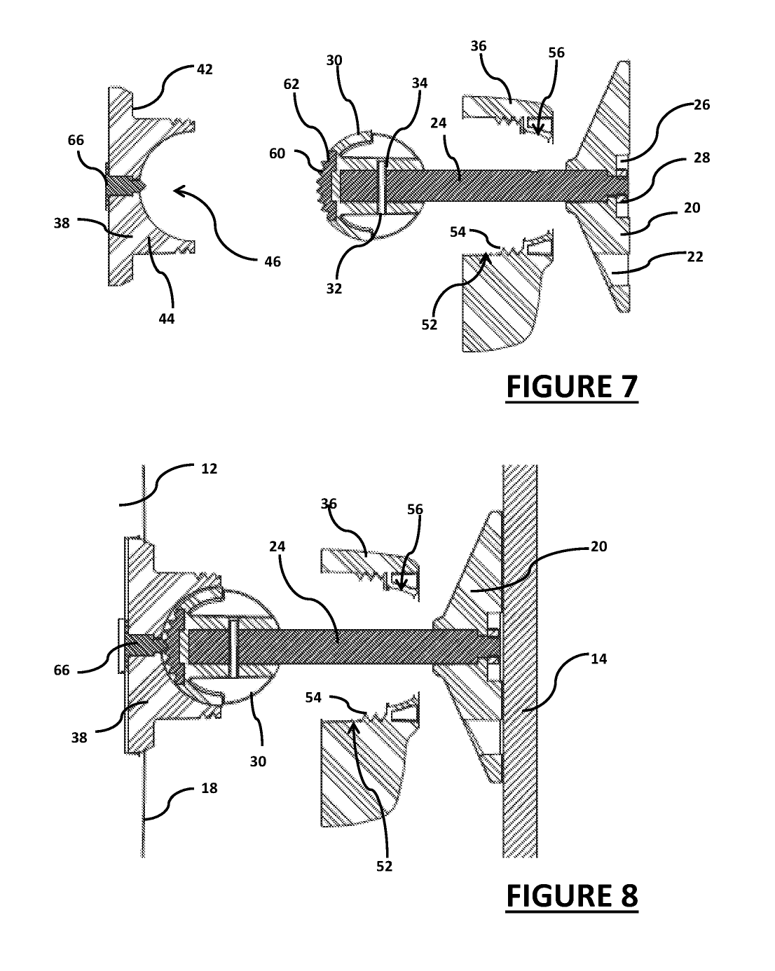

Projecting into the socket 46 is a locking pin 66. During assembly the locking pin is inserted through an aperture 68 provided in the second attachment plate 38. The locking pin 66 ends in a point 70. The locking pin is made from hardened steel, such as heat treated carbon steel. As can be seen from the cross-sectional views in FIGS. 7 to 9, the point 70 is sized and shaped to engage with an indentation 60. This allows for a positive mechanical interlock. This increases the weight of the speaker able to be suspended compared to existing bracket systems. This positive mechanical interlock also eliminates the sag that is evident in existing systems.

It will be appreciated that whilst the preferred embodiment illustrated provides the indentations on the ball mount and the locking pin in the socket, an alternative embodiment (not shown) could reverse this arrangement. The indentations may be provided in the socket and the locking pin may project from the end of the ball mount.

FIG. 7 shows the preferred embodiment with all of the components disengaged. The first module comprising the ball mount 30, the arm 24, the locking nut 36 and wall plate 20, is attached to wall surface 14, as shown in FIG. 8. The second module comprising the second attachment plate 38, which has the boss 44 with socket 46 and locking pin 66, is attached to the rear wall 18 of the loudspeaker 12.

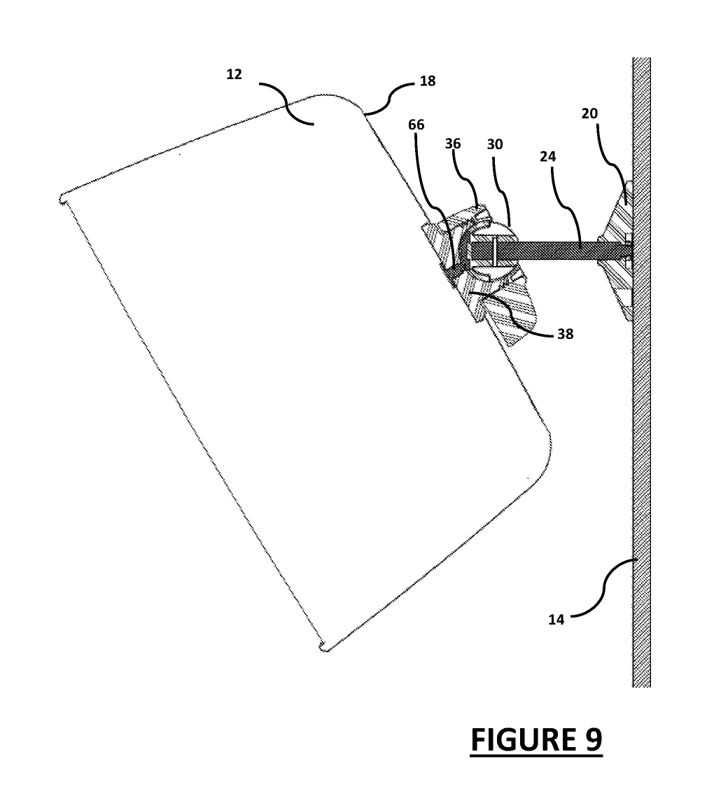

When the loudspeaker 12 is to be mounted to the wall 14 the speaker is positioned so that the socket 46 sits over the end of the ball mount 30, as shown in FIG. 8. Once in position the locking nut 36 is partially screwed onto the end of the boss 44. This secures the first module to the second module and suspends the loudspeaker 12 from the wall 14. When partially secured, the locking pin 66 is not fully engaged in any of the indentations 60. This gives the installer an opportunity to reorientate the loudspeaker 12 until the desired position is reached, for example downwardly tilted, as shown in FIG. 9. The installer can then press the speaker onto the ball to locate the desired indentation. The locking nut 36 can then be fully tightened by hand, drawing the ball mount further into the socket 46 engaging the locking pin 66 firmly into one of the indentations 60, as shown in FIG. 9. The tightening process will ensure that the locking pin will not be able to move from the interlocked position within its indentation counterpart.

To reorientate the speaker 12, the locking nut 36 can be loosened to disengage the locking pin 66 from the indentation 60. The speaker is still securely fastened to the wall and allows the installer to release their hold. The speaker can be freely reorientated to engage with a different indentation 60. Alternatively, the locking pin may not be completely disengaged from the indentation 60 and the speaker can be pivoted around the point 70 of the locking pin 66. For a rectangular speaker this could allow reorientation from a portrait positioning to a landscape positioning without changing the angle of the speaker relative to the wall.

Whilst the first module and second module may be inverted such that the ball mount is attached to the speaker, the preferred embodiment is as shown so that the ball is closer to the centre of gravity of the assembly i.e. closer to the rear of the speaker.

In an environment where the speakers may be used, there are typically several speakers grouped together. The present invention allows for easy orientation of all the speakers to face the same direction due to the predefined indentation spacing, which is replicated across mounting brackets. This allows the exact positioning to be replicated across multiple speakers.

The mounting bracket according to the present invention enables predefined multi-axis rotation of a speaker while securely holding it in place by the mechanical interlocking provided by the locking pin and indentations. This interlocking method allows multi-directional reorientation, simple reorientation between portrait and landscape speaker orientations, enables minimal use of force to secure it in place, and can withstand high weight loads.

It will be understood that the invention disclosed and defined in this specification extends to all alternative combinations of two or more of the individual features mentioned or evident from the text or drawings. All of these different combinations constitute various alternative aspects of the invention.

1. A multi-directional mounting bracket for adjustably mounting an object to a structure, including:
a first attachment means for attachment to the structure;
a second attachment means for attachment to an object to be supported;
a ball mount;
a socket for receiving the ball mount;
the ball mount and the socket connected to a respective first or second attachment means;
fastening means for securing the ball mount into the socket; and
locking means including an array of indentations on at least a portion of the surface of the ball mount or the socket, and a locking pin projecting from the other of the socket or the ball mount;
wherein the indentations define a plurality of predetermined positions whereby the locking pin can engage in an indentation and the fastening means locks that orientation, and wherein the fastening means can be loosened to disengage the locking pin from the indentation to allow reorientation of the object.

2. A multi-directional mounting bracket according to claim 1, wherein the array of indentations are located on the ball mount and the locking pin projects partially into the socket.

3. A multi-directional mounting bracket according to claim 1, wherein the first attachment means is an attachment plate for attachment to the structure and the second attachment means is a second attachment plate having a first face for attachment to an object to be supported.

4. A multi-directional mounting bracket according to claim 3, further including a boss projecting from a second face of the second attachment plate, the boss having an external thread, the inside of the boss forming the socket for receiving the ball mount.

5. A multi-directional mounting bracket according to claim 4, wherein the fastening means is a locking nut having an internal thread for engagement with the external thread of the boss.

6. A multi-directional mounting bracket according to claim 1, wherein the socket and the fastening means form a spherical housing when connected together for locking the ball mount in a predetermined position.

7. A multi-directional mounting bracket according to claim 1, wherein the ball mount has a number of indentations positioned on the exterior of the ball.

8. A multi-directional mounting bracket according to claim 7, wherein the indentations form a radial arrangement originating from the centre of the ball.

9. A multi-directional mounting bracket according to claim 7, wherein the indentations cover a small segment of the ball, or cover half of the spherical ball surface.

10. A multi-directional mounting bracket according to claim 1, wherein the array of indentations is provided as an insert into the ball body.

11. A multi-directional mounting bracket according to claim 1, wherein the array of indentations is formed directly into the ball body.

12. A multi-directional mounting bracket according to claim 1, wherein the indentations are either domed or cone shaped, allowing rotation around the locking pin to reorientate the object about a pivot point.

13. A multi-directional mounting bracket according to claim 1, wherein the socket has a number of indentations provided in the socket.

14. A multi-directional mounting bracket according to claim 1, wherein the fastening means allows the ball mount to be secured in the socket and hold the weight of the object without the indentations being engaged by the locking pin.

15. A multi-directional mounting bracket according to claim 1, wherein the fastening means is able to be hand operated without the need for additional tools.
